(19) United States
(12) Patent Application Publication
(10) Pub. No.: US 2018/0056377 A1
(43) Pub. Date: Mar. 1, 2018

(54) METHOD AND APPARATUS FOR CONTROLLING OF A COOLING PROCESS OF CASTING MOLDS FOR COSMETIC PRODUCTS

(71) Applicant: Weckerle GmbH, Weilheim (DE)

(72) Inventor: Sven Droste, Peibenberg (DE)

(21) Appl. No.: 15/688,431

(22) Filed: Aug. 28, 2017

(30) Foreign Application Priority Data
Aug. 31, 2016 (EP) 16186557.1

(51) Int. Cl. B22D 11/22; A61Q 1/06; B29C 45/73

(52) U.S. Cl. CPC B22D 11/22; B29C 2945/76076; B29C 45/73; A61Q 1/06

(57) ABSTRACT

An apparatus and a method for controlling a cooling process of casting molds for cosmetic products during passing through a cooling track in an installation are described. The apparatus comprises a means for determining at least one process parameter corresponding to a first casting mold, a means for controlling the passing time of a second casting mold through the cooling track based on the at least one process parameter, and a means for controlling a cooling behavior of the cooling track during passing through of the second casting mold based on the at least one process parameter.

### PRIOR APPLICATIONS

The present application claims priority to European Patent Application No. 16186557.1 filed Aug. 31, 2016, the contents of which are included herein by reference.

### TECHNICAL FIELD

The present invention relates generally to controlling of a cooling process of casting molds. The present invention relates, in particular, to the automatic controlling of a cooling process of casting molds in the production of cosmetic products, based on at least one determined process parameter in an installation.

### BACKGROUND

Cosmetic products, such as lipsticks and lipstick mines, respectively, are nowadays produced in almost fully automated installations. In these installations, a plurality of process steps of the manufacturing process take place successively and the cosmetic products are guided or directed through these process steps, wherein the finished cosmetic product is removed at the end of the installation. If the cosmetic product is, for example, lipstick mines, these are produced in several process steps. At first, a mixture of different waxes and additives is produced, which is the basic material of the lipstick mines. This basic material is heated to be converted into a flowable state. In a next process step, the flowable basic material is filled into a casting mold. The casting mold can be a production component in the installation. The casting mold is subsequently cooled so that the basic material can at least partially solidify in the casting mold in order to permanently get the shape of the casting mold. The heating of the mixture of the various waxes and additives, the filling of the casting molds with the flowable basic material, as well as the subsequent cooling of the casting molds, represent the three main process steps in the manufacturing of lipstick mines, which are carried out in the installation. However, further process steps may also be carried out alongside these main process steps. The production output of the installation, i.e. the number of items emitted per unit of time, is directly dependent on the times that the individual process steps make use of. The cooling process usually makes use of the longest time in comparison to the other two main process steps. The cooling process usually takes place in a cooling track. The cooling track represents an area or a zone of the installation in which the temperature level of the casting molds is reduced. In this case, the cooling track usually has a certain spatial extent and the casting molds are moved through the cooling track or move through it independently. Within the cooling track in most cases there is a controllable temperature level which is below the temperature level which the casting molds have after the filling. In the cooling track, entropy is thus withdrawn from the casting molds, such that the casting molds are cooled.

In the pursuit of the goal of optimizing the production output of the installation, the time required for the process steps must therefore be reduced. This is, however, not readily possible with respect to the cooling process, since the casting molds cannot be cooled as fast as desired but a defined cooling behavior must be maintained such that the waxes and additives do not solidify uncontrolled, which would result in damage to the surface, which would reduce the overall impression of the lipstick mines and make these appear no longer high-quality. It is therefore necessary to adjust the cooling process in such a way that it takes the shortest possible time, but takes into account the cooling behavior of the waxes and additives such that a high-quality product is present at the end of the cooling process.

Processes and apparatuses are known which attempt to increase the production output of installations for the manufacturing of lipstick mines. Thereby, the installations for lipstick mines have a so-called fluid production process, which is characterized by a continuous feeding of production components in the form of a circular clocking of the various process steps in the installation. The production process may be accelerated by ease of the principle of the process steps arranged immediately after one another during the circular clocking, since in the system, for example, the part of the transfer time between the process steps may be reduced over the entire production time.

EP 1 437 062 A1 describes, for example, an apparatus for the uninterrupted production of lipsticks which, among others, comprises the process steps for the heating, the filling and the cooling. Each of the process steps is carried out in a corresponding so-called zone of the installation. In the described apparatus, the casting molds are held accordingly by a circular table and the clocking of the table determines the speed at which the casting molds pass through the individual areas. However, the disadvantage of such an apparatus is that the individual process steps are dependent on one another. With an increase in the rate of filling the casting molds achieved by increasing the speed at which the casting molds are moved through the zone for filling, the speed at which the casting molds are moved through the zone for cooling also increases.

It is therefore the object to provide a method and an apparatus which do not have the above-mentioned disadvantage. In particular, with the method and the apparatus, the functional dependency between the duration of the cooling process and the cycle time of the other process steps in the installation is to be resolved.

### SUMMARY

This object is achieved by the method and the apparatus of the independent claims. Advantageous embodiments are described in the dependent claims.

The method according to the invention for controlling a cooling process of casting molds for cosmetic products passing through a cooling track in an installation comprises the determining at least of a first process parameter associated with a first casting mold. In addition, the method comprises the controlling of a passing time of a second casting mold through the cooling track based on the at least one first process parameter, and the controlling of a cooling behavior of the cooling track when the second casting mold passes through, based on the at least one first process parameter. The first casting mold, which passes through the cooling track, thereby performs a test function. For example, the cooling track in the installation may be initialized with the passing through of the first casting mold and with the determination of the at least one first process parameter. In the initialization phase, for example, only the first casting mold may pass through the cooling track, and the second casting mold may only be fed to the cooling track after the first casting mold has been completely passed through the cooling track. In this case, the passing time of the second casting mold and the cooling behavior of the cooling track during the passing through of the second casting mold may be adapted based on the first process parameter that has been determined for the first casting mold. For example, however, the second casting mold may also already be fed to the cooling track before the first casting mold has completely passed through the cooling track. In this case, the first casting mold may also be referred to as a primary casting mold, and the second casting mold may be referred to as a secondary casting mold. In this case, the secondary casting mold again performs the function of a primary casting mold for a further casting mold, which follows the second casting mold passing through the cooling track, therefore resulting in a closed loop. This means that the passing time of a subsequent casting mold and the cooling behavior of the cooling track for the subsequent casting mold are controlled based on at least the first process parameter determined for the previous casting mold. The closed loop may be direct, that is, a regulation may take place from a first casting mold for the directly following second casting mold. However, the closed loop may also be indirect, that is, a regulation may take place from a first casting mold for a subsequent second casting mold, wherein the second casting mold does not follow the first casting mold directly. This means that other casting molds may also pass through the cooling track between the first casting mold and the second casting mold. It will be appreciated by the person skilled in the art that, although only individual process steps of the method according to the invention are mentioned here, these process steps are carried out iteratively and thus a continuous regulation of the cooling process takes place. It is sufficient to determine one process parameter because this represents a desired state of the casting molds, the achievement of which is the goal of the control.

The cooling process may be controlled or regulated by controlling the passing time of the casting molds through the cooling track, whereby the passing time of the casting molds may be varied individually for each casting mold. This means that the dwell time of each casting mold in the cooling track may be adjusted individually. In this case, the infeed of the casting molds through the cooling track is also decoupled from the infeed which the casting molds experience in the other process steps. It may also be said that the cycle times of the casting molds in the different process steps are independent from one another. In order to control the passing time, the passing time of a first casting mold, which may be a primary casting mold, for example, through the cooling track may be compared with the at least one determined first process parameter, and the difference between an actual value and a desired value of the at least one process parameter may be determined. If the difference between the actual value and the desired value of the at least one first process parameter during the passing of the primary casting mold through the cooling track exceeds the threshold, the passing time of the secondary casting mold through the cooling track may be adapted such that the difference between the actual value and the desired value of the at least one first process parameter determined for the secondary casting mold, which is a primary casting mold for a subsequent casting mold, becomes lesser, until the difference is equal to or less than the threshold.

The cooling process may also be controlled by controlling the cooling behavior of the cooling track. The cooling behavior of the cooling track during the passing through of the first casting mold, which may be, for example, a primary casting mold, is initially compared with the at least one determined first process parameter, and thus the difference between an actual value and a desired value of the at least one first process parameter is determined. If the difference between the actual value and the desired value of the at least one first process parameter during the passing through of the primary casting mold through the cooling track, for example the temperature level provided by the cooling track, exceeds a threshold when the secondary casting mold passes through, the cooling behavior of the cooling track may be adapted such that the difference between the actual value and the desired value of the at least one process parameter, determined for the secondary casting mold, which is a primary casting mold for the subsequent casting mold, becomes lesser, until the difference is equal or less than the threshold.

The controlling the passing time may be independent of controlling the cooling behavior. This means that not in each iteration step, both the passing time and the cooling behavior need to be controlled. For example, one control variable may be kept constant and the other control variable may be changed. Also the keeping constant of at least one control variable falls under the concept of controlling.

The cooling track ensures that the entropy of the casting molds is reduced. With the control of the passing time and the cooling behavior of the cooling track, the entropy behavior of the casting molds may thus be determined. The cooling behavior of the casting molds may thus be predetermined. This behavior may accordingly be regulated via the presetting of a desired value for the first process parameter. The cooling behavior is also independent of the cycle times of the other processes in the installation.

In a preferred embodiment of the method according to the invention, the method further comprises the determining at least a second process parameter associated with the first casting mold. The at least one second process parameter may thereby differ from the first process parameter in that it is determined in a different area in the installation than the first process parameter. However, the process parameters may alternatively or additionally differ in that a different measurement variable is determined. For example, several second process parameters may be determined. The control of the passing time and/or the control of the cooling behavior may then additionally also be based on the at least one second determined process parameter in order to allow a more differentiated control.

The first and the at least one second process parameter may, for example, represent the temperature of the casting mold in different areas of the installation. The first process parameter may, for example, represent a first temperature of the first casting mold in front or behind the cooling track and, according to the determined first temperature, the passing time of the second casting mold through the cooling track may be controlled and the cooling behavior of the cooling track may be controlled. For example, the first process parameter may represent the first temperature of the first casting mold at the beginning of the cooling track or at the end of the cooling track.

During the passing through of the cooling track, the first casting mold is cooled from a high temperature level to a low temperature level, and the cooling may be monitored by ease of the determined first temperature. The determined first temperature represents an actual value and may be compared with a desired value, which may, for example, be predetermined by an operator. The difference between the actual value and the desired value may be used to monitor the extent to which the cooling process and the lowering of the temperature level from the first casting mold correspond to the requirements. The at least one desired value, which may be preset by the operator, may also be a threshold, and during the passing of the first casting mold through the cooling track, an overshooting or undershooting of the at least one threshold may be checked. Based on the overshooting or undershooting the at least one threshold, for example, the passing of the second casting mold through the cooling track and the cooling behavior of the cooling track itself may be controlled by, for example, varying the temperature level of the cooling track acting on the second casting mold and thus withdrawing entropy from the second casting mold. The cooling process during the passing of the second casting mold through the cooling track is adapted in such a way that the requirements with regard to the reduction in the temperature level of the second casting mold to be achieved may be better satisfied than with the passing of the first casting mold through the cooling track. The lowering of the temperature level to be achieved may, for example, comprise a temperature difference of 60 Kelvin. When the second casting mold passes through the cooling track, the passing time of the second casting mold may, for example, be shortened or lengthened such that the second casting mold either remains longer or shorter in the cooling track such that more or less entropy is withdrawn from the second casting mold.

The controlling the cooling behavior of the cooling track during passing of the second casting mold may include reducing or increasing the cooling power of the cooling track in at least one area of the cooling track. The cooling power may therefore be different in one area of the cooling track than in the at least one further area of the cooling track. This means that the cooling track may comprise different temperature levels in different areas.

For example, during the passing of the first casting mold, the temperature of the first casting mold in front of the cooling track and the temperature of the first casting mold at the end of the first area or the cooling track may be determined. The determined temperature at the end of the first area of the cooling track may be compared with a desired value, which may represent a first threshold. If the first threshold is exceeded during the passing of the first casting mold through the first area of the cooling track, this means that the temperature level of the first casting mold is too high at the end of the first area of the cooling track. In order to be able to better adjust the temperature level of the first casting mold at the end of the cooling track to the predefined temperature level and thus to lower it to the predefined temperature level at the end of the cooling track, the cooling power may be increased in the at least one further area of the cooling track. Conversely, the cooling power in the at least one further area of the cooling track may be reduced if, during the passing through of the first casting mold, the first threshold has been undershot. For the second casting mold, the cooling power in the first area of the cooling track may be increased when the determined temperature of the first casting mold has shown that the temperature level of the first casting mold was too high. Conversely, the cooling power for the second casting mold may be reduced if the temperature level of the first casting mold was too low. For example, the cooling power may also be averaged in both areas, from the determined temperature at the end of the at least one area.

In a further preferred embodiment of the method according to the invention, the method comprises adapting a number of the casting molds present in the installation, wherein the number of casting molds present in the installation is based on the first process parameter and/or at least a second process parameter. In order to reach the predetermined temperature of the casting molds at the end of the cooling track during the passing through of the casting molds through the cooling track, each casting mold or a group of casting molds may be moved through the cooling track at an individual speed, wherein the speed during passing through the cooling track may be different from the speed during the passing through of the other process steps in the installation. It may also be said that, during the passing through of the casting molds through the cooling track, there is no functional dependency between the duration of the cooling process and the cycle time of the other process steps in the installation. By the individual speed with which each casting mold or the group of casting molds may be moved through the cooling track and in that the speed of the casting molds during the passing through the cooling track may differ from the speed during the passing through of the other process steps in the installation, the distance between the casting molds may vary during the passing through of the cooling track. If, for example, the speed of a casting mold is increased during the passing through the cooling track, the distance between this casting mold and a subsequent casting mold increases.

Since the distance between the casting molds may be increased during passing through of the cooling track, gaps may form which may be large enough to provide enough space for at least one further casting mold. The control of the cooling process in the installation may determine the formation of gaps which are large enough to provide enough space for at least one further casting mold. Because gaps may form, the number of casting molds involved in the cooling process, that is, the number of casting molds that are simultaneously in the cooling track, may be increased by, for example, increasing the number of casting molds which are fed to the cooling track per unit of time. This may be initiated, for example, by increasing the speed with which the casting molds are fed into the cooling track. However, it is clear that the number of casting molds involved in the cooling process may not be increased arbitrarily. An upper limit is reached, for example, when the maximum occupancy of the cooling track is reached.

The number of casting molds involved in the cooling process may, however, not be further increased, for example, if no further casting molds are available in front of the cooling track for feeding to the cooling track. This may be the case, for example, if the number of casting molds which are produced per unit of time from the process step before the cooling track may not be further increased.

In the case that the maximum occupancy of the cooling track is not yet reached, but at the same time, however, no further casting molds are available in front of the cooling track, the method may comprise adding at least one casting mold to the installation and thus increasing the number of casting molds present in the installation, respectively. The number of casting molds present in the installation may be increased, for example, if the control of the cooling process in the system determines that the cooling track could be even more closely fed with casting molds because, for example, the first process parameter, that is, the first temperature of the first casting mold, is recurrently undershot at the end of the cooling track. Thus, the speed of the passing through of the second casting mold could be increased during passing through of the cooling track, which would open up further gaps between the casting molds that are present in the cooling track. If, on the other hand, the predetermined first process parameter is exceeded, for example, the speed of the passing through of the second casting mold may be reduced during passing through of the cooling track.

The reduction of the speed of the passing through of the casting molds through the cooling track, as opposed to an increase in the speed of the passing through, may cause a reduction in the distance between the casting molds, for example when the cycle time of the other process steps in the installation is not adjusted, although the cycle time of the cooling process was extended by the reduction of the speed of the passing through of the casting molds through the cooling track. However, the distance between two casting molds during the passing through of the cooling track may not be arbitrarily reduced, but only until the maximum occupancy of the cooling track, corresponding to the respective speed of the passing through, is achieved. A further reduction in the speed during the passing through of the cooling track is not possible without the cooling process throttling the other process steps in the installation and thus having a negative effect on the production output of the installation. Thus, the speed of the passing through of the cooling track of the casting molds may not be arbitrarily reduced. In this case, casting molds may be removed from the system. With the removal of at least one casting mold from the installation, the number of casting molds present in the installation may be adapted such that the cooling power per casting mold is increased and the cooling track is, where necessary, again sufficient for the casting molds involved in the cooling process, that is the casting molds being present in the cooling track at the same time, cool down according to the requirements without the cooling process adversely affecting the speed of the other process steps in the installation. This step may be iteratively repeated until the minimum degree of loading is reached until the cooling power of the cooling track is sufficient.

In a further preferred embodiment of the method according to the invention, the method comprises feeding the first casting mold into the cooling track before feeding the second casting mold into the cooling track. Furthermore, the method according to the invention may comprise feeding at least the first and/or second casting mold into a buffer area in the installation after the passing through of the cooling track. The buffer area is used for receiving at least one casting mold after the passing through of the cooling track in the event that the passing time of the at least one casting mold is shortened by the cooling track so as to counteract the forming of a congestion, which may occur at the end of the cooling track when the passing time of the casting molds through the cooling track is short. It can also be said that by feeding the at least one casting mold into the buffer area in the installation, accumulation of the casting molds at the end of the cooling track may be prevented. The speed with which the at least one casting mold is guided through the buffer area may be individually varied for each casting mold. For example, the number of casting molds fed to the buffer area per unit of time may be varied and the number of casting molds leaving the buffer area per unit of time may be constant. This principle may be maintained as long as the number of casting molds located in the buffer area does not exceed a threshold. If the threshold of the number of casting molds which are located in the buffer area is exceeded, for example, the number of casting molds leaving the buffer area per unit of time may be increased. The number of casting molds which are fed to the buffer area per unit of time may also be reduced, for example by extending the passing time of at least one casting mold through the cooling track. If the number of casting molds, which are located in the buffer area, can not be reduced without adversely affecting the production capacity of the installation, the number of casting molds present in the installation may be reduced, for example, as described above.

It is also clear that, by ease of the method according to the invention, the operation of the installation for the production of cosmetic products may be simplified, since the operator merely must at least specify the desired value of a first process parameter, which may be a temperature. Based on the at least one process parameter, the control system automatically adjusts the cooling power of the cooling track, for example, its temperature level, as well as the passing time of the casting molds through the cooling track such that an optimal cooling behavior of the cooling track may be provided.

The above-mentioned object is also achieved by an apparatus for controlling a cooling process of casting molds for cosmetic products during passing through a cooling track in an installation. The apparatus comprises a means for determining at least one process parameter associated with a first casting mold, and a means for controlling a passing time of a second casting mold through the cooling track based on the at least one process parameter, and a means for controlling a cooling behavior of the cooling track during passing through of the second casting mold, based on the at least one process parameter.

In a preferred embodiment of the apparatus according to the invention, the means for determining the at least one process parameter is adapted to determine at least one temperature. The means for determining may also be adapted to determine a first and second process parameter, for example at two different areas of the installation, and the first and second process parameter may each be a temperature. The means for determining the temperature may be a pyrometer with which the heat radiation which is emitted from the surface of the casting molds may be measured without contact. On the basis of a known degree of emission from the surface of the casting molds, the temperature from the surface of the casting molds may then be determined from the measured heat radiation. For example, the heat radiation emitted by the pasty mass may also be measured without contact with the pyrometer. In the course of a measurement, the pyrometer determines a specific area on the surface of the casting molds or on the surface of the pasty mass, which can be referred to as a measuring surface, wherein the measuring surface is generally smaller than the entire surface of the casting molds or as the entire surface of the pasty mass. The pyrometer may be integrated into the installation such that it is at least movable about an axis and/or along an axis, whereby the pyrometer may be oriented differently for different measurements in order to measure the heat radiation of different measuring surfaces on the surface of different casting molds or on the surface of different pasty masses. There may be at least one pyrometer in the installation. The alignment of the at least one pyrometer may be caused, for example, by means of a stepping motor. Alternatively, the at least one pyrometer may also be aligned by means of a servomotor. For example, hydraulic or pneumatic actuators may also be used for the alignment of the at least one pyrometer. However, other means for contactless or contacted temperature measurement may also be used.

In a preferred embodiment of the apparatus according to the invention, the means for controlling the passing time of the casting molds through the cooling track is adapted to vary the speed at which the casting molds are guided through at least one area of the cooling track. The means for controlling the passing time of the casting molds through the at least one area of the cooling track may be a linear transport system for a flexible positioning and movement of the casting molds within the installation, wherein the casting molds are supported by at least one mold carrier and wherein a mold carrier may carry at least one casting mold. The at least one mold carrier may be flexibly positioned and moved within the installation.

In a preferred embodiment of the apparatus according to the invention, the means for controlling the cooling behavior of the cooling track is adapted to vary the cooling power of the cooling track in at least one area of the cooling track. The means for controlling the cooling power of the cooling track in at least one area of the cooling track may be, for example, a drive with which the angle of incidence of at least one ventilation grid may be controlled in the at least one area of the cooling track in order to vary the temperature level in the at least one area of the cooling track. The at least one ventilation grid may, for example, be driven by at least one stepping motor. A stepping motor is a multiphase synchronous motor, which is pulse-controlled by ease of an electronic circuit. In the case of a pulsed-drive, the motor shaft carries out a rotation about a specific angle of rotation, the so-called step angle. For example, the cooling power of the cooling track may also be controlled in at least one region of the cooling track by ease of a control of the rotational speed of at least one fan. The means, by which the rotational speed of the at least one fan may be controlled, may be a servomotor. A servomotor is an electric motor, which may control the angular position and the rotational speed of the motor shaft by ease of a sensor for position determination. Further means for controlling the cooling power of the cooling track in at least one area of the cooling track are known to the person skilled in the art, for example the cooling power of the cooling track in at least one area of the cooling track may be controlled by ease of the control of the power of at least one pump, with which for example a cooling medium may be pumped, which may flow around the casting mold during the passing through of the at least one area of the cooling track. Furthermore, the temperature of the cooling medium, which flows around the casting molds during the passing through of the at least one area of the cooling track, may be controlled in the at least one area of the cooling track.

In a further preferred embodiment of the apparatus according to the invention, the apparatus comprises a means for adjusting a number of the casting molds present in the installation, based on the at least one process parameter, wherein the means for adjusting is adapted for removing at least one casting mold from the installation or for adding at least one casting mold to the installation. The casting molds may be carried by a mold carrier, wherein a mold carrier carries at least one casting mold. The means for removing at least one casting mold from the installation and for adding at least one casting mold to the installation may be a means by which a fully automatic transfer of the carrier is made possible.

In a further preferred embodiment, the apparatus according to the invention comprises a means for determining a number of the casting molds present in the installation. The means by which the number of casting molds present in the installation may be determined may, for example, be a sum counter which comprises the function of a memory as well as the function of an upwards counter and downwards counter. The upwards counting may be an addition and the downwards counting may be a subtraction. For example, when casting molds are added to the installation, the number of casting molds present in the installation is increased by a certain amount by addition, wherein the first summand is the number of casting molds present in the installation before adding the casting molds and the second summand is the number of added casting molds. When casting molds are removed from the installation, the number of casting molds present in the installation is reduced by a certain amount by the subtraction, wherein the minuend represents the number of casting molds present in the installation before removing the casting molds and the subtrahend is the number of removed molds. The sum counter may store the number of casting molds that are present in the installation, and thus the number of casting molds present in the installation is known at any time. The determination of the number of casting molds, which are added to the installation or which are removed from the installation, may be carried out by ease of at least one sensor. The at least one sensor may, for example, be a light barrier, which may be positioned such that a signal is sent to the sum counter whenever a casting mold passes through the light barrier. For example, at least one further light barrier may be used. For example, one light barrier may monitor the adding of casting molds to the installation and the at least one further light barrier may monitor the removing of casting molds from the installation. Alternatively, the at least one sensor may also be a visual recognition system, for example a camera which may be positioned in such a way that the adding of casting molds to the installation and the removing of casting molds from the installation may be monitored, and that a signal is send to the sum counter every time a casting mold is removed from or added to the installation. Other means are known to the person skilled in the art to recognize the number of production components in the installation. For example, an RFID system may also be used, wherein each of the casting molds may be equipped with an RFID transponder and the adding of casting molds to the system and the removing of casting molds from the system may be recognized by ease of at least one RFID reader.

### BRIEF DESCRIPTION OF THE DRAWINGS

The invention is explained in more detail below with reference to exemplary embodiments with the accompanying drawings. Further details, features and advantages of the subject-matter of the invention arise from the exemplary embodiments described herein. It shows:

FIG. 1 a top view of an exemplary installation with a schematical depiction of the process steps;

FIG. 2 the exemplary installation shown in FIG. 1 with a division of the cooling track in three areas.

### DETAILED DESCRIPTION

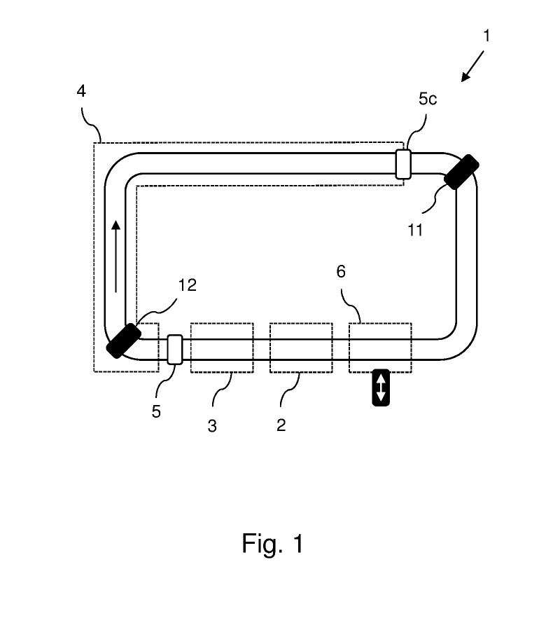

FIG. 1 shows schematically an installation 1 for the production of cosmetic products, in which different process steps are carried out in the areas 2, 3, 4. The areas 2, 3, 4 are arranged successively. In the installation 1, for example, lipstick mines are produced. In this case, casting molds 11, 12 are heated in area 2, and a heated pasty mass, for example consisting of waxes and additives, is then filled in the casting molds 11, 12 in area 3. Subsequently, the casting molds 11, 12 are cooled in an area 4. The area 4 may also be referred to as a cooling track. The casting molds 11, 12 pass through the individual regions during the production process, wherein the casting molds are held, for example, by mold carriers, and wherein the mold carriers are moved on a transport system which moves the casting molds 11, 12 through the individual areas 2, 3, 4. In this case, the mold carriers may, for example, move independently of one another. In the exemplary embodiment shown here, the first casting mold 11 has already passed through the area 4, i.e. the cooling track, while the second casting mold 12 is still at the beginning of the area 4. The person skilled in the art is aware that a mold carrier may also hold a plurality of casting molds, in which case a first casting mold is one of the casting molds held by a first mold carrier, and a second casting mold is a casting mold of several casting molds held by a second mold carrier.

Although not shown here, the person skilled in the art is aware that, an area, in which the cooled lipstick mines may be removed from the casting molds, may follow the cooling track 4.

In the exemplary embodiment shown here, the installation 1 also has two sensors 5, 5c, by ease of which process parameters, here the temperature of the casting molds 11, 12 or the pasty mass in the casting molds 11, 12, may be determined at the sensor location. In the exemplary embodiment shown here, the temperature of the casting molds 11, 12 is determined. The sensor 5 is located at the beginning of the cooling track 4 and the sensor 5c is located at the end of the cooling track 4.

The temperatures determined by the sensors 5, 5c represent actual values and are compared with predetermined desired values, which are, for example, predetermined by an operator. In accordance with the deviation of the actual value from the desired value, the passing time of the casting molds 11, 12 and the cooling power of the cooling track 4 are controlled.

In the exemplary embodiment shown here, for example, the actual temperature of the first casting mold 11 in front of the cooling track 4 was determined by the sensor 5 and the actual temperature of the first casting mold 11 behind the cooling track 4 with the sensor 5c. Based on the deviation of the at least one actual temperature from the desired temperature, the passing time of the second casting mold 12 through the cooling track 4 and the cooling power of the cooling track 4 are controlled. The passing time and/or the cooling power is controlled in such a way that the difference between the actual temperature and the desired temperature is as low as possible. This control may be carried out even more differentiated if it is known how high the actual temperature of the first casting mold 11 was in front of the cooling track 4 and how high the actual temperature of the second casting mold 12 was in front of the cooling track 4. When the second casting mold 12 has passed the cooling track 4, its actual temperature is determined by the sensor 5c. This detected actual temperature and its deviation from the desired temperature is subsequently used to control the passing time of a casting mold following the second casting mold—not shown here—and/or to control the cooling power of the cooling track 4 for the corresponding casting mold. This provides an iterative control, which independently regulates the passing time and the cooling power, in order to achieve an optimum cooling process, whereby the operator has only to specify the desired values without having to intervene in any other way. It is known to the person skilled in the art that the predetermined desired value may also be predetermined by a higher-level control, whose programming, however, has been carried out by an operator so that the desired value is at least indirectly set by an operator.

The person skilled in the art is aware that the positions of the sensors 5, 5c and their number shown in this exemplary embodiment are only exemplary, and a larger number of sensors 5, 5c may also be used and these may also be located differently.

The casting molds 11, 12 may, for example, be supported by mold carriers—not shown here—, whereby a mold carrier may at least carry a casting mold. In the exemplary embodiment shown here, the casting molds 11, 12 or the mold carriers carrying the casting molds 11, 12 may be exchanged. This means that the casting molds 11, 12 may be removed from the installation 1 or other casting molds—not shown here—may be added to the installation 1. As a result, the number of mold carriers which are located in the installation 1 and thus the number of casting molds located in the installation 1 may be adapted. This may be done, for example, in an exchange area 6 of the installation 1.

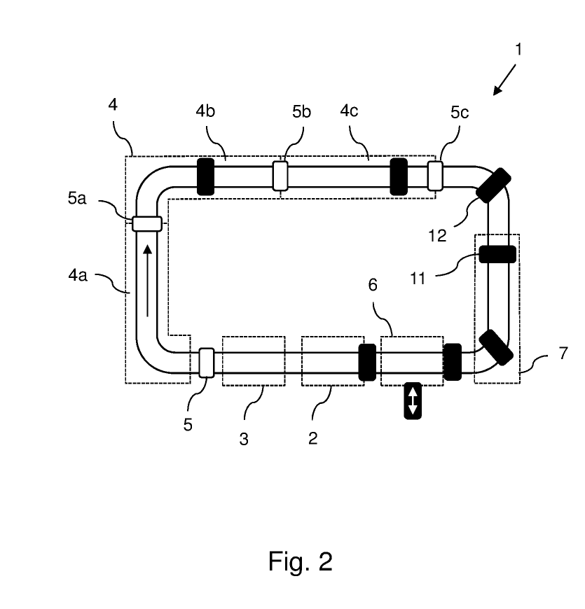

FIG. 2 once again shows the installation 1 shown in FIG. 1 for the production of cosmetic products, but with a division of the cooling track 4 into three areas 4a, 4b, 4c. Each of the areas 4a, 4b, 4c of the cooling track 4 has an associated temperature sensor 5a, 5b, 5c with which the temperature of the casting molds may be detected at the end of each of the areas 4a, 4b, 4c of the cooling track 4. The plurality of temperature sensors 5a, 5b, 5c make it possible to control the passing times and cooling powers iteratively for the casting molds passing through in the individual areas 4a, 4b, 4c of the cooling track 4 according to an actual-desired value comparison, wherein the casting molds or the mold carriers may move individually, i.e. independently of one another, through the installation 1. As a result, the individual mold carriers or casting molds may have different passing times, which is indicated by their different distances in the exemplary embodiment shown here.

However, in order that the areas 2 and 3 may at least operate with a constant clocking, which is precisely necessary in the filling area 3, in order, for example, to ensure a constant flow of the pasty mass from feeding lines without the filling having to be interrupted again and again, this installation 1 also comprises a buffer area 7 into which the casting molds may be fed after passing through the cooling track 4. In this buffer area 7, the casting molds may first be collected and fed into the area 2 in a certain clock pulse, for example every 3 seconds, such that a constant clocking may be ensured at least in regions 2 and 3.

It will be understood by the person skilled in the art that the exemplary embodiments shown are only exemplary, and that all the elements, modules, components, participants and units shown may have different configurations but may nevertheless fulfill the basic functionalities described here.

1. A method for controlling a cooling process of casting molds for cosmetic products during passing through a cooling track in an installation, the method comprising:
determining a first process parameter corresponding to a first casting mold;
controlling the passing time of a second casting mold through the cooling track based on the first process parameter; and
controlling the cooling behavior of the cooling track during the passing through of the second casting mold based on the first process parameter.

2. The method according to claim 1, further comprising:
determining at least one second process parameter corresponding to the first casting mold.

3. The method according to claim 2, wherein the controlling of the passing time is further based on the at least one second process parameter and/or wherein the controlling of the cooling behavior is further based on the at least one second process parameter.

4. The method according to claim 2, wherein the controlling of the passing time comprises:
shortening the passing time of the second casting mold through the cooling track, if the first and/or the at least one second process parameter falls below a threshold; and
extending the passing time of the second casting mold through the cooling track, if the first and/or the at least one second process parameter exceeds a threshold.

5. The method according to claim 2, wherein the controlling the cooling behavior comprises:
reducing the cooling power in at least one area of the cooling track, if the first and/or the at least one second process parameter falls below a threshold; and
increasing the cooling power in at least one area of the cooling track, if the first and/or the at least one second process parameter exceeds a threshold.

6. The method according to claim 2, further comprising:
adjusting a number of casting molds being present inside the installation based on the first and/or the at least one second process parameter.

7. The method according to claim 6, wherein the adjusting of the number comprises:
removing at least one casting mold from the installation or adding at least one casting mold to the installation.

8. The method according to claim 1, further comprising:
feeding the first casting mold to the cooling track before the feeding the second casting mold to the cooling track.

9. The method according to claim 1, further comprising:
feeding of at least the first and/or the second casting mold to a buffer area inside the installation after the passing through of the cooling track.

10. The method according to claim 2, wherein the first and/or the at least one second process parameter each is a temperature.

11. An apparatus for controlling a cooling process of casting molds for cosmetic products during passing through a cooling track in an installation, the apparatus comprising:
a means for determining at least one process parameter corresponding to a first casting mold;
a means for controlling a passing time of a second casting mold through the cooling track based on the at least one process parameter; and
a means for controlling the cooling behavior of the cooling track during the passing through of the second casting mold based on the at least one process parameter.

12. The apparatus according to claim 11, wherein the means for controlling the passing time is adapted to vary the velocity with which the second casting mold is guided through at least one area of the cooling track and/or
wherein the means for controlling the cooling behavior is adapted to vary the cooling power of the cooling track in at least one area of the cooling track.

13. The apparatus according to claim 11, further comprising:
a means for recognizing a number of casting molds being present in the installation.

14. The apparatus according to claim 11, further comprising:
a means for adjusting a number of casting molds being present in the installation, wherein the means for adjusting is adapted to remove at least one casting mold from the installation or to add at least one casting mold to the installation.

15. The apparatus according to claim 11, wherein the means for determining of the at least one process parameter is adapted to determine a first and at least one second process parameter, wherein the first and the second process parameter each is a temperature.
